(19) United States
(12) Patent Application Publication
(10) Pub. No.: US 2026/0339697 A1
(43) Pub. Date: Oct. 29, 2026

(54) REQUEST PROCESSING METHOD, COMPUTING DEVICE AND MEDIUM

(71) Applicant: CLOUD INTELLIGENCE ASSETS HOLDING (SINGAPORE) PRIVATE LIMITED, Singapore (SG)

(72) Inventors: Heqing JIANG, Hangzhou, Zhejiang (CN); Jun LIU, Hangzhou, Zhejiang (CN); Jialiang LIN, Hangzhou, Zhejiang (CN)

(73) Assignee: CLOUD INTELLIGENCE ASSETS HOLDING (SINGAPORE) PRIVATE LIMITED, Singapore (SG)

(21) Appl. No.: 19/123,418

(22) PCT Filed: Oct. 13, 2023
(86) PCT No.: PCT/CN2023/124393

§ 371 Date: Apr. 23, 2025

(30) Foreign Application Priority Data
Oct. 24, 2022 (CN) 202211304750.9

(51) Int. Cl. G06F 9/48

(52) U.S. Cl. CPC G06F 9/4843; G06F 2209/485

(57) ABSTRACT

A request processing method and system are provided. The request processing method is applied to the request processing system. The system comprises an allocation node and at least two task processing nodes, and the method comprises: by the allocation node, receiving at least two to-be-processed requests, and receiving task response messages sent by the at least two task processing nodes, where each of the task response messages carries a task processing weight, and allocating, based on the task processing weight and the at least two to-be-processed requests, a corresponding to-be-processed request set to a first task processing node; and by the first task processing node, performing task processing on one or more to-be-processed requests in a received to-be-processed request set, updating the task processing weight according to current processing state information during the performing task processing, and sending the updated task processing weight to the allocation node.

### CROSS REFERENCE TO RELATED APPLICATIONS

This disclosure is a National Stage of International Application PCT/CN2023/124393, filed on Oct. 13, 2023, which claims priority to Chinese Patent Application No. 202211304750.9, entitled “REQUEST PROCESSING METHOD AND SYSTEM” filed with the China National Intellectual Property Administration (CNIPA) on Oct. 24, 2022, the entire contents of the mentioned applications are incorporated herein by reference.

### TECHNICAL FIELD

Embodiments of the present specification relate to the field of computer technologies, and in particular, to a request processing method.

### BACKGROUND

With the continuous development of Internet technologies, when receiving requests, a service end may need to invoke other service ends to process the requests; and if the requests are to be allocated to the other service ends by the service end, to improve request processing efficiency, a load sharing manner will be adopted to allocate requests to each of the other service ends according to current processing states thereof.

In the prior art, the service end monitors the current processing states of the other service ends. However, this manner may have a problem of delay, as the service end cannot learn of the current processing states of the other service ends in time, thereby reducing the request processing efficiency.

### SUMMARY

In view of this, according to embodiments of the present specification, a request processing method is provided. One or more embodiments of the present specification relate to a request processing system, another two request processing methods, two request processing apparatuses, a computing device, a non-transitory computer-readable storage medium, and a computer program, to resolve technical defects in the prior art.

According to a first aspect of the embodiments of the present specification, a request processing method applied to a request processing system is provided, where the system includes an allocation node and at least two task processing nodes, and the method includes:
by the allocation node, receiving at least two to-be-processed requests, and receiving task response messages sent by the at least two task processing nodes, where each of the task response messages carries a task processing weight, and
allocating, based on the task processing weight and the at least two to-be-processed requests, a corresponding to-be-processed request set to a first task processing node among the at least two task processing nodes, wherein the first task processing node is one of the at least two task processing nodes; and
by the first task processing node, performing task processing on one or more to-be-processed requests in a received to-be-processed request set, updating the task processing weight according to current processing state information during the performing task processing, and sending the updated task processing weight to the allocation node based on the task response messages.

According to a second aspect of the embodiments of the present specification, a request processing system is provided, where the system includes an allocation node and at least two task processing nodes, where
the allocation node is configured to: receive at least two to-be-processed requests, receive task response messages sent by the at least two task processing nodes, where each of the task response messages carries a task processing weight; and
allocate, based on the task processing weight and the at least two to-be-processed requests, a corresponding to-be-processed request set to a first task processing node among the at least two task processing nodes, where the first task processing node is one of the at least two task processing nodes; and
the first task processing node is configured to: perform task processing on one or more to-be-processed requests in a received to-be-processed request set, update the task processing weight according to current processing state information during the performing task processing, and send the updated task processing weight to the allocation node based on the task response messages.

According to a third aspect of the embodiments of the present specification, a request processing method applied to a task processing node is provided, including:
generating a task response message based on a task processing weight, and sending the task response message to an allocation node;
receiving a to-be-processed request set determined by the allocation node for the task processing node, where the to-be-processed request set is determined by the allocation node based on the task processing weight and at least two received to-be-processed requests;
performing task processing on one or more to-be-processed requests in the received to-be-processed request set, and updating the task processing weight according to current processing state information during the performing task processing; and
sending the updated task processing weight to the allocation node based on the task response message.

According to a fourth aspect of the embodiments of the present specification, a request processing apparatus applied to a task processing node is provided, including:
a first sending module, configured to generate a task response message based on a task processing weight, and send the task response message to an allocation node;
a receiving module, configured to receive a to-be-processed request set determined by an allocation node for the task processing node, where the to-be-processed request set is determined by the allocation node based on the task processing weight and at least two received to-be-processed requests;
a processing module, configured to perform task processing on one or more to-be-processed requests in the received to-be-processed request set, and update the task processing weight according to current processing state information during the performing task processing; and
a second sending module, configured to send the updated task processing weight to the allocation node based on the task response message.

According to a fifth aspect of the embodiments of the present specification, a request processing method applied to an allocation node is provided, including:
receiving at least two to-be-processed requests, and receiving task response messages sent by at least two task processing nodes, where each of the task response messages carries a task processing weight; and
allocating, based on the task processing weight and the at least two to-be-processed requests, a corresponding to-be-processed request set to a first task processing node among the at least two task processing nodes, where the first task processing node is one of the at least two task processing nodes.

According to a sixth aspect of the embodiments of the present specification, a request processing apparatus applied to an allocation node is provided, including:
a receiving module, configured to receive at least two to-be-processed requests, and receive task response messages sent by at least two task processing nodes, where each of the task response messages carries a task processing weight; and
an allocation module, configured to allocate, based on the task processing weight and the at least two to-be-processed requests, a corresponding to-be-processed request set to a first task processing node among the at least two task processing nodes, where the first task processing node is one of the at least two task processing nodes.

According to a seventh aspect of the embodiments of the present specification, a computing device is provided, including:
a memory and a processor;
the memory is configured to store computer-executable instructions, the processor is configured to execute the computer-executable instructions, and when the computer-executable instructions are executed by the processor, the steps of the request processing methods above are implemented.

According to an eighth aspect of the embodiments of the present specification, a computer-readable storage medium is provided, storing computer-executable instructions, where when the instructions are executed by a processor, the steps of the request processing methods above are implemented.

According to a ninth aspect of the embodiments of the present specification, a computer program is provided, where when the computer program is executed in a computer, the computer is enabled to perform the steps of the request processing methods above.

The request processing method provided according to an embodiment of the present specification is applied to a request processing system, the system includes an allocation node and at least two task processing nodes, and the method includes: by the allocation node, receiving at least two to-be-processed requests, and receiving task response messages sent by the at least two task processing nodes, where each of the task response messages carries a task processing weight; and allocating, based on the task processing weight and the at least two to-be-processed requests, a corresponding to-be-processed request set to a first task processing node among the at least two task processing nodes, where the first task processing node is one of the at least two task processing nodes; and by the first task processing node, performing task processing on one or more to-be-processed requests in a received to-be-processed request set, updating the task processing weight according to current processing state information during the performing task processing, and sending the updated task processing weight to the allocation node based on the task response messages.

Specifically, according to the method, each task processing node can determine a task processing weight according to current processing state information during the task processing and actively send the determined task processing weight to an allocation node; while the allocation node can determine, based on the task processing weight, current processing state of each task processing node quickly and accurately, thereby avoiding the problem of delay. And then, when receiving to-be-processed requests, the allocation node can allocate, based on the current processing state of each task processing node, the to-be-processed requests to corresponding task processing node, thereby improving the request processing efficiency.

### BRIEF DESCRIPTION OF DRAWINGS

FIG. 1 is a schematic diagram of allocating requests according to an embodiment of the present specification.

FIG. 2 is a schematic diagram of applying a request processing method according to an embodiment of the present specification.

FIG. 3 is a flowchart of a request processing method according to an embodiment of the present specification.

FIG. 4 is a schematic diagram illustrating a change in concurrent acceleration on an abnormal service end in a request processing method according to an embodiment of the present specification.

FIG. 5 is a schematic diagram illustrating changes of concurrent amount under different functions in a request processing method according to an embodiment of the present specification.

FIG. 6 is a schematic diagram of a processing procedure of a request processing method according to an embodiment of the present specification.

FIG. 7 is a schematic diagram of standalone concurrent amount in a request processing method according to an embodiment of the present specification.

FIG. 8 is a flowchart of another request processing method according to an embodiment of the present specification.

FIG. 9 is a flowchart of still another request processing method according to an embodiment of the present specification.

FIG. 10 is a schematic structural diagram of a request processing system according to an embodiment of the present specification.

FIG. 11 is a structural block diagram of a computing device according to an embodiment of the present specification.

### DETAILED DESCRIPTION

Many specific details are set forth in the following description to facilitate a thorough understanding of the present specification. However, the present specification can be implemented in many other manners different from those described herein, and those skilled in the art may perform similar promotion without departing from the scope of this specification, so the present specification is not limited by the specific implementation disclosed below.

Terms used in one or more embodiments of the present specification are for the purpose of describing embodiments only and are not intended to limit one or more embodiments of the specification. As used in one or more embodiments of the specification and the appended claims, the singular forms “a”, “the” and “said” are also intended to include plural forms, unless the context clearly indicates other meanings. It should also be understood that the term “and/or” as used in one or more embodiments of the present specification refers to and encompasses any or all possible combinations of one or more associated listed items.

Although the terms first, second, etc. may be used to describe various information in one or more embodiments of the present specification, the information should not be limited to these terms. These terms are only used to distinguish the same type of information from each other. For example, without departing from the scope of one or more embodiments of the present specification, first may also be referred to as second, and similarly, second may also be referred to as first. Depending on context, the word “if” as used herein may be interpreted as “when” or “upon” or “in response to a determination”.

Firstly, terms referenced in one or more embodiments of the present specification are explained.

Service Concurrent (Amount): the number of instantaneous requests being processed by a server at a certain moment.

Request Rate: the total number of requests sent in a certain period.

Response Speed: the time taken for a single request being processed from starting to completion.

Load Balancing: selecting an optimal address from a plurality of addresses through a certain algorithm, and thereby ensuring the maximum utilization of all address resources can be achieved in a case that the number of requests reaches a certain degree.

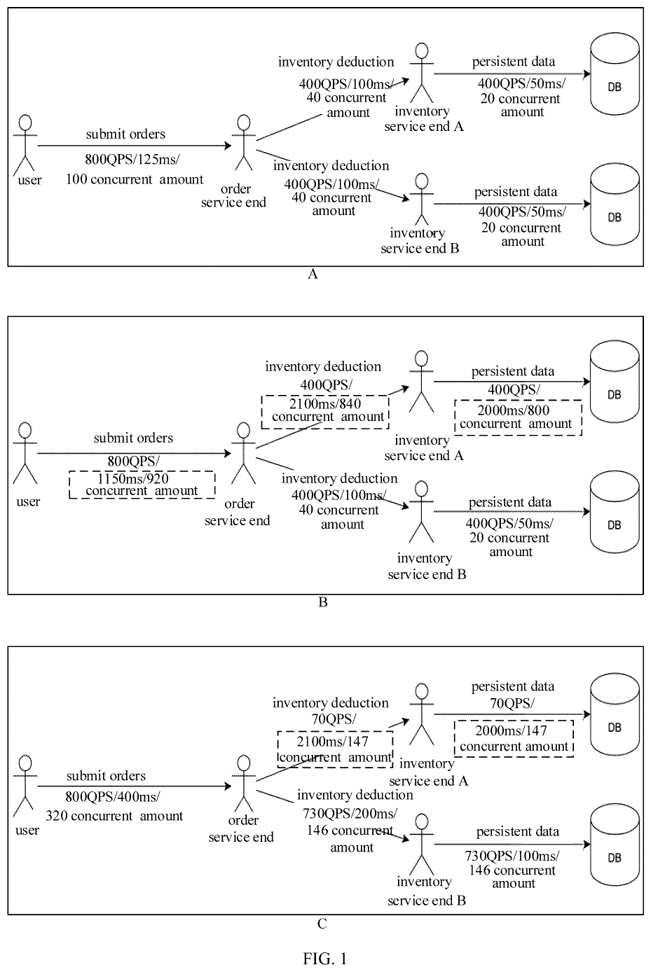

With the continuous development of Internet technologies, when receiving requests, a service end may need to invoke other service ends to process the requests; and if the requests are to be allocated to the other service ends by the service end, to improve request processing efficiency, a load sharing manner will be adopted to allocate requests to each of the other service ends according to current processing states thereof. For example, for most microservice applications, a service end, to provide a service, generally needs to serve as a consumer end and depends on several other services to process requests received by the service end; while for most services exposing data management capabilities to outside, it is necessary to rely on a database for processing. Referring to FIG. 1, it is a schematic diagram of allocating requests of an order service according to an embodiment of the present specification. As shown in part A of FIG. 1, an order service end relies on a service from an inventory service end to perform inventory deduction, and the inventory service end needs to rely on a database to perform data persistence. Where QPS indicates a request rate, and ms indicates a response speed. However, in an actual production environment, due to problems such as slow processing from the database (DB) and network jitter, services provided by the inventory service end may be blocked, and the instantaneous concurrent amount is greatly increased, which brings extreme pressure to a machine and even cause service down. Referring to part B of FIG. 1, it simulates a request processing in a scenario where a slow processing problem exists in a database. In a case that a problem occurs in a connection of the inventory service end A with the database, processing a single request needs 2000 ms, which causes the instantaneous concurrent amount on the inventory service end A to increase to 840, as framed by a dotted line part in the figure, and further causes the concurrent amount of upstream order services to even increase from 80 to 880. As a result, a half of the processing duration of user requests reaches more than 2100 ms, which brings poor factors to a user request experience or stability of the entire system. It can be seen that, for most microservice applications, if the processing performance of the service end occurs a jitter, the instantaneous concurrent amount of the service end may instantaneously increase to a high level due to the overall slow processing of requests, which directly results in a service unavailability or even a service avalanche.

In view of the above, in the present specification, for the problem of instantaneous concurrent growth caused by service end blocking, three processing schemes are provided, including an unlimited scheme, a maximum concurrent limited scheme, and a load balancing scheduling scheme at a perspective of a client.

However, all the above solutions may cause instantaneous concurrent growth due to service end blocking. According to the maximum concurrent limited scheme, when the instantaneous concurrent amount of a service end reaches a certain number, the service end will reject to receive a new request, and this solution is to sacrifice a certain number of successful requests to ensure the overall performance of the application. According to this scheme, once the limitation is achieved, a new request will be rejected and thus brings poor experience to a user. As shown in part C of FIG. 1, the maximum concurrent amount is set to 100, about 352 requests are rejected per second, and accordingly the concurrent amount of applications on full links as a whole would not be extremely high. The maximum concurrent limitation has two limited manners, one is that each service end has an exclusive concurrent degree, and the other is that multiple service ends share one concurrent degree. In the exclusive concurrent manner, if the limited value is relatively great, the problem such as memory overflow may still occur when multiple services are blocked, and if the limited value is relatively small, the exclusive concurrent manner is not suitable for some intensive IO services. In the shared mode, a certain service end being blocked may result in that other service ends in the same service group cannot receive new requests, which affects normal requests. Generally, the exclusive concurrent manner is not used by default and only be provided based on customer configuration. Therefore, the maximum concurrent limited scheme has two relatively large disadvantages: one is that the number of successful requests decreases, which brings bad experience to users; and the other is that normal service ends are affected when an abnormal service end is limited, which expands the influence.

The other is unlimited scheme, and the concurrent amount is allowed to increase without any limitation. According to the unlimited scheme, when the concurrency on a single service end is growing, the processing capacity is continuously expanded so as to meet the requirement of the concurrency. Due to the fact that the capacity expansion is unlimited, the number of concurrent requests increasing brings some pressure to the provider and the overall processing duration of all services becomes longer along with the increase of the pressure. Moreover, when the concurrent amount reaches a certain number, memory overflow of a process is likely to occur.

The third way is to perform load balancing scheduling at the perspective of the client. Where, by consumer ends sensing indicators such as response time of the service ends, an optimal service end in the service granularity may be selected at the consumer end standalone. Common algorithms include, for example, a least active algorithm, a fastest response algorithm. However, these algorithms can only be used for scheduling traffic at a standalone perspective of the consumer end, while cannot be used for timely and efficiently acquiring a real standalone performance of each service end. In addition, algorithms such as the least active algorithm and the fastest response algorithm depend on indicators such as machine configuration and response time in the cluster to work well, and misjudgement can easily occur in a complex mixing scene.

In view of this, in this specification, a request processing method is provided, and this specification also relates to a request processing system, another request processing method, a request processing apparatus, a computing device, and a computer-readable storage medium, which are described in detail in the following embodiments.

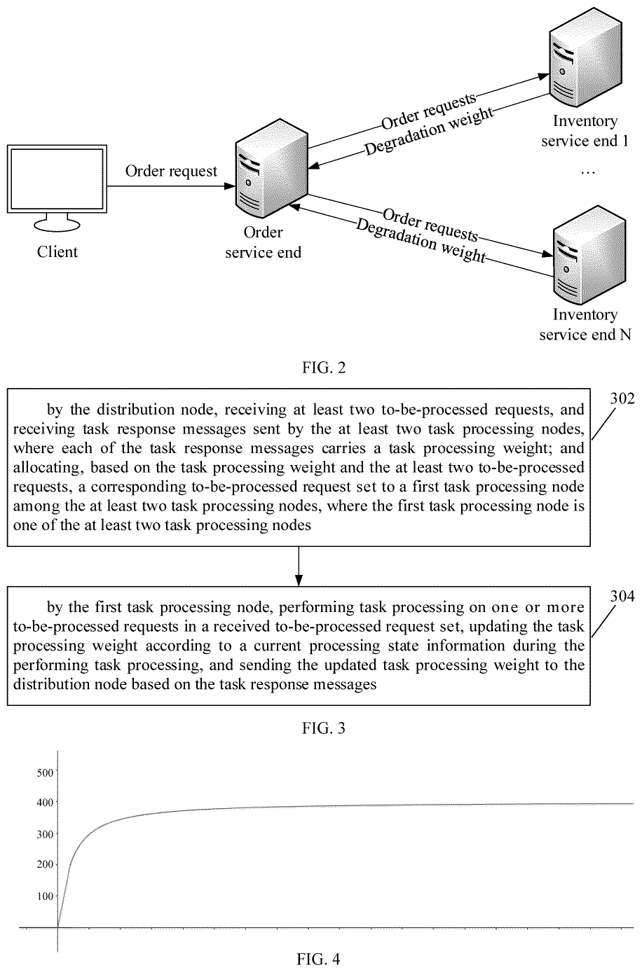

Referring to FIG. 2, it is a schematic diagram of applying a request processing method according to an embodiment of the present specification. It should be noted that the request processing method provided in this specification uses a dynamic weight pushing manner, in which an invoking speed of a problematic service end is reduced by means of weight scheduling while ensuring that the maximum concurrent amount does not exceed expectation. On a premise of avoiding a trouble caused by directly throwing an abnormality to the user, it can be ensured that the pressure of a single service end does not exceed the upper limit. In view of this, referring to FIG. 2, according to the request processing method provided in the present specification, in an invocation link between an order service end (which may be used as a consumer end) and an inventory service end, a data path for returning weight data from the service end to the consumer end is added. When the load of the service end is high, the inventory service end may determine a degradation weight according to the load condition thereof, and send the degradation weight to the consumer end through the data path. And afterwards, when the consumer end is to initiate invoking to multiple inventory service ends based on the order requests sent by the client, the consumer end will allocate order requests by using the new weight, thereby reducing the number of requests received by a service end with a high load or an abnormal service end, and realizing load sharing. On the basis, the request processing method provided in the present specification aims to, by the service end reversely sending an adaptive degradation weight, perform intelligent traffic scheduling in a cluster, so as to realize service degradation isolation of an abnormal standalone node, prevent resource occupation from being infinitely expanded, achieve rapid fault convergence, and greatly reduce the influence on the user.

Referring to FIG. 3, it shows an application flowchart of a request processing method according to an embodiment of the present specification, where the request processing method is applied to a request processing system, the system includes an allocation node and at least two task processing nodes, and the method specifically includes the following steps.

In step 302, the allocation node receives at least two to-be-processed requests, and receives task response messages sent by the at least two task processing nodes, where each of the task response messages carries a task processing weight; and the allocation node allocates a corresponding to-be-processed request set to a first task processing node among the at least two task processing nodes based on the task processing weights and the at least two to-be-processed requests, where the first task processing node is one of the at least two task processing nodes.

Where the task processing node may be understood as a node capable of processing the to-be-processed requests, and may be a task processing service end. For example, the task processing service end may be the above inventory service end and logistics service end, and may be realized by one or more servers. The allocation node may be understood as a service end capable of allocating to-be-processed requests received or generated by itself to task processing nodes associated therewith; and may also be referred to as a consumer end. For example, the allocation node may be the order service end described above, and the order service end may receive order requests sent by the user through a user terminal. The to-be-processed request may be understood as a user request sent by the user to the allocation node with a terminal. For example, the to-be-processed request may be an order request or a data obtaining request. Alternatively, the to-be-processed request may also be understood as a request generated by the allocation node according to the user request sent by the user. For example, when a shopping order request is sent to an order service node from the user and is processed by the order service end, the order service end may have to send an inventory deduction request to an inventory service end, so as to deduct the inventory number of the commodity by invoking a service of the inventory service end, and thereby avoiding a problem that the user cannot obtain the commodity due to the fact that the inventory number is not reduced after the commodity is sold. The to-be-processed request set may be understood as a set including a specific number of to-be-processed requests.

The task response message may be understood as a message sent by the task processing node to the allocation node through the data path between them, where the message carries a task processing weight.

The task processing weight may be understood as a parameter representing a request processing capability of the task processing node, and may be of any value in a value range, for example, any value in a value range of [0, 1] or [0, 100]. That is, the task processing node generates the task processing weight according to current task processing information of the task processing node when performing task processing, and the task processing weight is used to represent information about a task processing status of the task processing node. It should be noted that, in the request processing method provided in this specification, the task processing weight is calculated by the task processing node itself and fed back to the allocation node. Therefore, by reversely sending the weight, a channel for the service end feeding back to the consumer end is established, thereby providing feasibility for the service end to protect itself.

The following describes the request processing method by taking an application of the request processing method in an e-commerce scenario as an example, where the allocation node is an order service end, the task processing node is an inventory service end, the to-be-processed requests are inventory deduction requests, and the task processing weight may be a weight corresponding to each inventory service end. Based on this, the inventory service end may determine its own task processing weight according to current processing state information of the inventory service end itself when performing a current deducting, generate a weight adjustment message based on information of the weight, and send the weight adjustment message to the order service end.

The order service end receives each weight adjustment message sent by each inventory service end, and determine the weight of each inventory service end from received weight adjustment message(s). When receiving a shopping order processing request for a commodity sent by the user through a client terminal, the order service end generates an inventory deduction request for the commodity, where the number of the shopping order processing requests is consistent with the number of the inventory deduction requests. Then, the order service end can allocate, according to the weight of each inventory service end, a specific number of inventory deduction requests to each inventory service end, and send the inventory deduction requests to corresponding inventory service ends. That is, according to the request processing method provided in this specification, by the inventory service end feeding back its own pressure information via sending weight, a problem of service success rate reduction caused by directly rejecting requests can be effectively avoided, which ensures that a normal service end can continue to be processed, and isolates a fault within a single service end.

According to an embodiment of this specification, a request processing method is provided. when performing request distribution, a corresponding number of to-be-processed requests are determined for each of the task processing nodes based on the task processing weight representing the current processing state of each of the task processing nodes, and allocated to the corresponding task processing nodes, thereby realizing load sharing for the task processing nodes, and realizing the intelligent traffic scheduling in a cluster. Specifically, allocating the corresponding to-be-processed request set to the first task processing node among the at least two task processing nodes includes:
determining, by the allocation node, request set information corresponding to the first task processing node among the at least two task processing nodes based on the task processing weight of the first task processing node; and
constructing, by the allocation node, the to-be-processed request set corresponding to the first task processing node based on the request set information and the at least two to-be-processed requests, and sending, by the allocation node, the to-be-processed request set to the first task processing node.

Where the request set information may be understood as information for constructing the request set information, for example, the request set information may be the number of to-be-processed requests that need to be allocated to each of the task processing nodes.

Specifically, the determining request set information corresponding to the first task processing node among the at least two task processing nodes based on the task processing weight of the first task processing node includes:
determining, by the allocation node, the first task processing node form the at least two task processing nodes, and determining the task processing weight of the first task processing node; and
determining, by the allocation node, based on the number of requests of the at least two to-be-processed requests, the number of nodes of the at least two task processing nodes and the task processing weight, a request processing number of the first task processing node, and taking, by the allocation node, the request processing number as the request set information.

Specifically, in order to realize load sharing for the task processing nodes and intelligent traffic scheduling in a cluster, the allocation node first needs to determine the first task processing node from the at least two task processing nodes, and then determine the task processing weight of the first task processing node from the task processing weights recorded by itself, when determining a corresponding request processing number for each of the task processing nodes.

Then, the allocation node needs to determine the number of requests of the at least two to-be-processed requests and the number of nodes of the at least two task processing nodes; and then, based on the number of requests, the number of nodes and the task processing weight of the first task processing node, calculate the number of to-be-processed requests which are to be allocated to the first task processing node (hereinafter, also named as the request processing number of the first task processing node); and determine the request processing number as request set information required for constructing the to-be-processed request set.

Along with the above example, the order service end needs to determine the weight of the inventory service end A when determining the number of requests that need to be allocated to the inventory service end; then determine the total number of inventory deduction requests and the total number of inventory service ends; and calculate the number of requests that need to be allocated to the inventory service end A based on the weight of the inventory service end A, the total number of inventory deduction requests and the total number of inventory service ends. In practical applications, the number of requests may be calculated by the following formula (1):

$$\frac{A * DeWeight}{DeWeight + B - 1} . \qquad ( 1 )$$

Where A represents the total request rate of the order service end (consumer end), i.e., the number of orders, and B represents the total number of inventory service ends. DeWeight represents the weight of each inventory service end. The number of requests allocated to each of the inventory service ends may be referred to as request rate of each of the inventory service ends, where a normal inventory service end may be understood as an inventory service end with a weight of 1, an abnormal inventory service end may be understood as an inventory service end with a weight less than 1, and based on this, the request rate H of the abnormal inventory service end is degraded to

$$H = \frac{A * DeWeight}{DeWeight + B - 1} ( 0 \leq We ight \leq 1 ) .$$

The request rate of the normal service end is

$$I = \frac{A}{DeWeight + B - 1} .$$

It should be noted that, according to the request processing method provided in this specification, the number of requests that need to be allocated to each task processing node is determined based on the weight provided by each task processing node, and based on this, concurrent function of the abnormal service end may be obtained by substituting the above request rate parameters, as shown in the following formula (2):

$$J = \frac{D \frac{ADeWeight}{DeWeight + B - 1}}{1000} = \frac{A * D * DeWeight}{1000 * ( DeWeight + B - 1 )} = \frac{A * D * \frac{Max Con - J}{Max Con - Min Con}}{1000 * ( \frac{Max Con - J}{Max Con - Min Con} + B - 1 )} . \qquad ( 2 )$$

Where J represents the concurrent amount of the abnormal service end; MaxCon represents a predetermined threshold for the concurrent amount, referred to as the maximum number of concurrent actions; MinCon represents a predetermined threshold for the concurrent amount, referred to as the minimum number of concurrent actions; and MaxCon is greater than MinCon.

For ease of calculation, it is assumed that the minimum number of concurrent actions may be 200, the maximum number of concurrent actions may be 400, and the concurrent function (formula 2) of the abnormal service end may be simplified to the following formula (3):

$$J ( A ) = \{ \begin{matrix}\frac{A}{2} , A < 400 \\ \frac{( 1000 + 2 A − \sqrt[2]{{( 1000 + 2 A )}^{2} − 3200 A}}{2} , 400 \leq A\end{matrix} . \qquad ( 3 )$$

The change in concurrent acceleration on the abnormal service end may be calculated based on the above concurrent function of the abnormal service end, referring to FIG. 4, it is a schematic diagram illustrating a change in concurrent acceleration on an abnormal service end in a request processing method according to an embodiment of the present specification. As shown in FIG. 4, it can be seen that after the total request rate A increases to 400 and the concurrent amount increases to 200, the concurrent acceleration on the abnormal server is slowed down and finally converges near the highest concurrent amount with 400.

Specifically, the constructing the to-be-processed request set corresponding to the first task processing node based on the request set information and the at least two to-be-processed requests includes:
obtaining, by the allocation node, one or more target to-be-processed requests corresponding to the request processing number of the first task processing node from the at least two to-be-processed requests; and
constructing, by the allocation node, the to-be-processed request set corresponding to the first task processing node based on the one or more target to-be-processed requests; wherein the to-be-processed request set comprises the one or more target to-be-processed requests.

Specifically, after determining the request processing number of the first task processing node, the allocation node obtains to-be-processed requests corresponding to the request processing number of the first task processing node from the at least two to-be-processed requests; and takes the to-be-processed requests corresponding to the request processing number as the target to-be-processed requests that need to be allocated to the first task processing node; and then constructs the to-be-processed request set corresponding to the first task processing node based on the one or more target to-be-processed requests, where the to-be-processed request set includes the one or more target to-be-processed requests; and sends the to-be-processed request set to the first task processing node, so as to prevent resource occupation from being infinitely expanded, achieve rapid fault convergence, and greatly reduce the influence on the user.

In the request processing method provided in the present specification, the to-be-processed requests include to-be-processed orders.

Accordingly, the allocating, based on the task processing weight and the at least two to-be-processed requests, corresponding to-be-processed request set to a first task processing node among the at least two task processing nodes comprises:
allocating, by the allocation node and based on an order task processing weight and at least two to-be-processed orders, a corresponding to-be-processed order set to a first order processing node among at least two order processing nodes.

Where the to-be-processed orders may be understood as commodity orders that need to be processed, the order processing node may be understood as a service end capable of processing the commodity orders, and the service end may be formed by one or more servers.

The allocation node may be understood as a service end that allocates the to-be-processed orders to the order task processing nodes.

Along with the above example, the allocation node indicates an order distribution service end, and the first order processing node may be a commodity order processing service end. Based on this, when the load of the commodity order service end is high, the commodity order service end may determine a degradation weight according to the load condition thereof, and send the degradation weight to the order distribution service end. And afterwards, when the order distribution service end is to initiate invoking to multiple commodity order processing service ends based on the commodity order requests sent by the client, the order distribution service end will allocated commodity orders by using the new weight, thereby reducing the number of requests received by the service end with a high load or the abnormal service end, and realizing load sharing.

In step 304, the first task processing node performs task processing on one or more to-be-processed requests in a received to-be-processed request set, updates the task processing weight according to current processing state information during the performing task processing, and sends the updated task processing weight to the allocation node based on the task response messages.

Where the current processing state information may be understood as information representing a current processing state of the first task processing node, or may be understood as information representing a current load condition of the service end. For example, the current processing state information may be the current concurrent amount of the first task processing node, a memory occupancy rate of the first task processing node, a CPU (Central Processing Unit) occupancy rate of the first task processing node, and the like.

When the to-be-processed requests indicate inventory deduction requests, the performing task processing on one or more to-be-processed requests may be understood as deducting commodity inventory data stored in a database associated with the first task processing node based on the inventory deduction requests.

Specifically, the updating the task processing weight according to current processing state information during the performing task processing comprises:
by the first task processing node, monitoring the current processing state information during the performing task processing; and
updating, in response to determining that the current processing state information satisfies a predetermined condition for updating weight, the task processing weight based on the current processing state information and a predetermined parameter for updating weight.

It should be noted that the current processing state information may indicate the number of current concurrent requests, and based on this, determining that the current processing state information satisfies a predetermined condition for updating weight comprises:
determining, by the first task processing node and in response to determining that the number of current concurrent requests is greater than or equal to a predetermined minimum threshold for concurrent requests, the current processing state information satisfies the predetermined condition for updating weight.

The predetermined minimum threshold for concurrent requests may be understood as a predetermined value, and may be used by the first task processing node to determine its load condition, for example, the predetermined minimum threshold for concurrent requests MinCon. If the concurrent amount of the current service end is less than the minimum number of concurrent actions, the weight is not degraded, and the weight of the current service end is kept consistent with weights of other normal service ends. If the concurrent amount of the current service end is higher than the minimum number of concurrent actions, the weight of the current service end needs to be recalculated, so as to check the load condition of the current service end in real time, thereby preventing the service end from being influenced by request occupation infinitely expanded.

It should be noted that the current processing state information indicates information of a current processing resource, and the current processing resource may be understood as a resource required by the first task processing node for task processing, for example, a CPU resource and a memory resource of the service end. The information of the current processing resource may be understood as information representing usage of the current processing resource, for example, CPU utilization, memory utilization, and the like. Based on this, the determining that the current processing state information satisfies a predetermined condition for updating weight comprises:
determining, by the first task processing node and in response to determining that the information of the current processing resource is greater than or equal to a predetermined resource threshold, the current processing state information satisfies the predetermined condition for updating weight.

The predetermined resource threshold may be understood as a predetermined value, and may be used by the first task processing node to determine its load condition, for example, a threshold of the CPU utilization is 90%.

Along with the above example, according to the request processing method provided in the present specification, the inventory service end is capable of detecting its CPU utilization in real time. In the case where the CPU utilization of 95% of the inventory service end is greater than or equal to a predetermined threshold of CPU utilization of 90%, it is determined that the inventory service end is in a load state, and it is necessary to adjust the weight of the inventory service end, so as to check the load condition thereof in real time, thereby preventing the service end from being influenced by request occupation infinitely expanded.

Specifically, the first task processing node in the request processing method provided in this specification is able to monitor the current processing state information in real time during performing task processing by itself, and in response to determining that the current processing state information satisfies the predetermined condition for updating weight, the task processing weight thereof can be updated based on the current processing state information and the predetermined parameter for updating weight.

The current processing state information indicates the number of current concurrent requests, and the predetermined parameter for updating weight comprises a predetermined minimum threshold for concurrent requests and a predetermined maximum threshold for concurrent requests; and based on this, the updating the task processing weight based on the current processing state information and a predetermined parameter for updating weight comprises:
by the first task processing node, determining the predetermined minimum threshold for concurrent requests and the predetermined maximum threshold for concurrent requests; and
obtaining updated task weight information based on the predetermined minimum threshold for concurrent requests, the predetermined maximum threshold for concurrent requests and the number of current concurrent requests, and replacing the task processing weight based on the updated task weight information.

The predetermined maximum threshold for concurrent requests may be understood as a predetermined value, and may be used by the first task processing node to determine its load condition, and the predetermined maximum threshold for concurrent requests is greater than the predetermined minimum threshold for concurrent requests. It should be noted that in the request processing method provided in this specification, two adjustment factors (which are respectively the minimum number of concurrent actions MinCon and the maximum number of concurrent actions MaxCon), a pushing data (degradation weight DeWeight), and an adjustment manner (a customized adjustment curve) are designed. In practical applications, if the concurrent amount of the current service end is less than the minimum number of concurrent actions, the weight is not degraded, and the weight of the current service end is kept consistent with weights of other normal service ends. In addition, the task processing node dynamically controls the weight value thereof in the cluster between the minimum number of concurrent actions and the maximum number of concurrent actions, provides the capability of fault shielding when the task processing node is abnormal, and implements disaster tolerance of the service cluster. By calculating and updating the weight of the service end, an optimal solution of traffic scheduling among a plurality of discrete service ends is realized when a single point of abnormality exists.

If the concurrent amount of the current service end is higher than the minimum number of concurrent actions, the degradation weight is determined according to the current concurrent amount, and sent to the consumer end, where the degradation weight decreases as the current concurrent amount increases. The decreasing trend in the decreasing process is controlled by the customized adjustment curve, which may be a linear function curve or a quadratic function curve, a cubic function curve or the like. The higher the number of functions, the faster the convergence speed of the performance in the service end.

Along the above example, before reaching the minimum number of concurrent actions, the processing rate of the service end is consistent with the foregoing situation; but after reaching the minimum number of concurrent actions, the weight of the service end needs to be degraded. Therefore, the inventory service end needs to determine the predetermined minimum number of concurrent actions and the maximum number of concurrent actions, and then recalculate the degradation weight thereof based on the minimum number of concurrent actions, the maximum number of concurrent actions and the current concurrent amount. The service end performs capacity evaluation based on the current concurrent amount, so that the sent weight value has quasi-real-time performance, thereby avoiding information lag. Where the degradation weight may be determined according to the following formula (4):

$$DeWeight = \frac{Max C o n - C u r C o n}{Max C o n - Min C o n} . \qquad ( 4 )$$

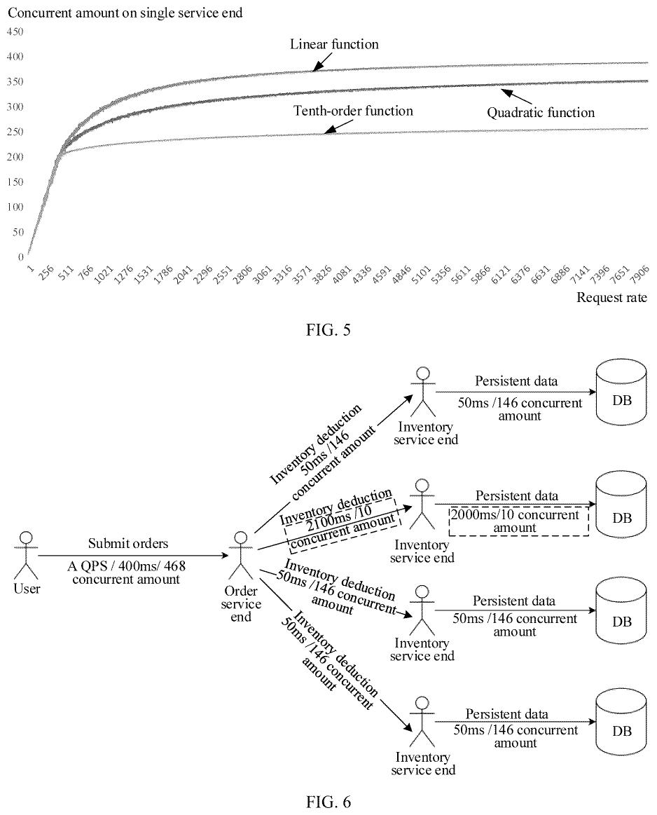

It should be noted that for ease of description, a linear function is adopted as the customized adjustment curve. However, a quadratic or ten-order functions may also be used. Referring to FIG. 5, it is a schematic diagram illustrating changes of the concurrent amount under different functions in a request processing method according to an embodiment of the present specification. FIG. 5 shows fitting curves of a concurrent amount growth when a linear function, a quadratic function and a ten-order function are adopted as the customized adjustment curve respectively. As shown in FIG. 5, it can be seen that as the number of functions increases, the concurrent amount is less affected by the request rate, and the protection efficiency on the service end is higher. In addition, when the current concurrent amount reaches the maximum number of concurrent actions, the degradation weight is 0, representing that no request is accepted any more, ensuring that the current concurrent amount of the machine never exceeds the maximum number of concurrent actions.

In the request processing method provided in the present specification, the task processing node can determine the task processing weight according to the current processing state information during the performing task processing and actively send the determined task processing weight to the allocation node. While the allocation node can determine, based on the task processing weight, current processing state of each task processing node quickly and accurately, thereby avoiding the problem of delay. And then, when receiving the to-be-processed requests, the allocation node can allocate, based on the current processing state of each task processing node, the to-be-processed requests to the corresponding task processing node, thereby improving the request processing efficiency.

With reference to FIG. 6, the following further describes the request processing method by taking an application of the request processing method provided in this specification in an order processing scenario as an example. FIG. 6 shows a schematic diagram of a processing procedure of a request processing method according to an embodiment of the present specification, where the order service end (i.e., a consumer end) can receive commodity orders provided by a user. And during processing the commodity orders by the order service end, in order to avoid the problem that the user cannot obtain the commodity due to the fact that the inventory number is not reduced after the commodity is sold, the order service end needs to send the inventory deduction requests to the inventory service end (i.e., a service end corresponding to the consumer end), so as to deduct the inventory number of the commodity by invoking a service of the inventory service end. Based on this, the process of invoking an inventory deduction service provided by the inventory service end by the order service end through the inventory deduction request is as follows.

It should be noted that, in FIG. 6, a total request rate of the order service end is A qps, the total number of inventory service ends is B (B>1), a response speed of the normal inventory service end is C ms, and a response speed of the abnormal inventory service end is D ms (D>C). Based on this, it can be determined that before the weight is adjusted, the request rate of each inventory service end is

$$E = \frac{A}{B} ,$$

the concurrent amount of the normal inventory service end is

$$F = \frac{CE}{1000} ,$$

and the concurrent amount of the abnormal inventory service end is

$$G = \frac{D E}{1000} .$$

Based on this, referring to FIG. 6, B is taken as 2, C is taken as 50, and D is taken as 2000, representing 4 inventory service ends in total. The response speed of the normal inventory service end is 50 ms, and the response speed of the abnormal inventory service end is 2000 ms. It can be obtained that a growth function of concurrent amount in the normal inventory service end is

$$F = \frac{A}{80} .$$

A growth function of concurrent amount in the abnormal inventory service end is

$$G = \frac{A}{2} .$$

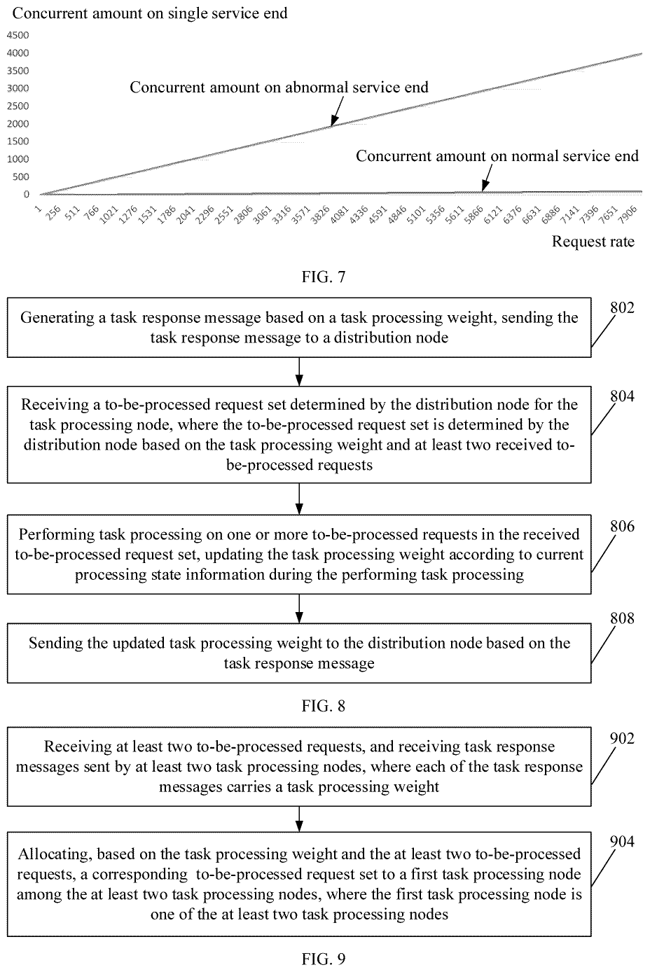

Referring to FIG. 7, it is a schematic diagram of standalone concurrent amount in a request processing method according to an embodiment of this specification; FIG. 7 is obtained by substituting the above growth function of concurrent amount for calculation. As shown in FIG. 7, even if the total request rate reaches 8000 QPS, the standalone concurrent amount of the normal inventory service end is only 100, and the concurrent amount of the abnormal inventory service end has increased to 4000, which is far beyond a concurrent range that a general service end can withstand. Based on this, after the current concurrent amount of the service end reaches the minimum number of concurrent actions MinCon, the degradation weight of the abnormal inventory service end is determined through the formula

$$DeWeight = \frac{Max C o n - C u r C o n}{Max C o n - Min C o n} ,$$

and the degradation weight is sent to the order service end.

Then during sending the inventory deduction requests to a plurality of inventory service ends by the order service end, in order to prevent resource occupation from being infinitely expanded, achieve rapid fault convergence, and greatly reduce the influence on the user, the order service end can determine a corresponding request rate for each inventory service end according to the weight which is provided by each inventory service end and represents the load condition thereof. Specifically, the degradation weight is substituted into the formula

$$H = \frac{A * DeWeight}{DeWeight + B - 1}$$

to determine the request rate of the abnormal inventory service end, that is, the number of inventory deduction requests that needs to be allocated to the abnormal inventory service end, and a corresponding number of inventory deduction requests are sent to the abnormal inventory service end. According to the request processing method provided in the present specification, a problematic service end is degraded in time by means of dynamic perception calculation of a delay to reduce the influence. Referring to FIG. 6, it shows upstream and downstream states after weight ratio of the problematic and unproblematic inventory service providers is reduced from 1:1 to 10.5:1. The average delay and delay of requests on the user side are greatly optimized, and the high concurrent on the full link is also relieved.

It should be noted that, for problems of the above unlimited scheme, the maximum concurrent limited scheme and the load balancing scheduling scheme at the perspective of the client, according to the request processing method provided in this specification, the maximum concurrent amount is limited by defining two adjustment factors of the minimum number of concurrent actions and the maximum number of concurrent actions, thereby fundamentally solving the problem of infinite expansion of resource occupation in the unlimited solution. In addition, a request proportion distribution of the consumer end is adjusted by means of a combination of weight pushing and the customized adjustment curve, thereby avoiding direct processing of requests. The impact on user experience is reduced by way of transferring request targets. Meanwhile, since the abnormal service end does not reject all requests for processing, the requests can also be received normally by normal services in the abnormal service end to achieve abnormal shielding between services. In addition, performance calculation of the service end itself is relatively real-time and accurate, and high efficiency and correctness of degradation isolation can be ensured by means of flow limiting of the service end itself at the perspective thereof.

In conclusion, according to the request processing method provided in the present description, the concurrent amount of the service end itself is protected at the perspective thereof, so that the single service end, the abnormal service, the normal service, the overall stability of the cluster and the user experience are greatly improved.

Referring to FIG. 8, it shows a flowchart of another request processing method according to an embodiment of the present specification, where the request processing method is applied to a task processing node, the method specifically includes the following steps.

In step 802, a task response message is generated based on a task processing weight, and the task response message is sent to an allocation node.

In step 804, a to-be-processed request set determined by the allocation node for the task processing node is received, where the to-be-processed request set is determined by the allocation node based on the task processing weight and at least two received to-be-processed requests.

In step 806, task processing is performed on one or more to-be-processed requests in the received to-be-processed request set, and the task processing weight is updated according to current processing state information during the performing task processing.

In step 806, the updated task processing weight is sent to the allocation node based on the task response message.

For explanation of the another request processing method, refer to corresponding or relevant content in the above mentioned request processing method, and details are not described herein again.

According to the another request processing method applied to the task processing node provided in the present specification, the task processing node can determine the task processing weight according to the current processing state information during the performing task processing and actively send the determined task processing weight to the allocation node. While the allocation node can determine, based on the task processing weight, current processing state of each task processing node quickly and accurately, thereby avoiding the problem of delay. And then, when receiving the to-be-processed requests, the allocation node can allocate, based on the current processing state of each task processing node, the to-be-processed requests to the corresponding task processing node, thereby improving the request processing efficiency.

The above mentioned is a schematic solution of the another request processing method according to this embodiment. It should be noted that the technical solution of the another request processing method and the technical solution of the above mentioned request processing method belong to the same concept, and details that are not described in detail in the technical solution of the another request processing method may refer to descriptions of the technical solution of the above mentioned request processing method.

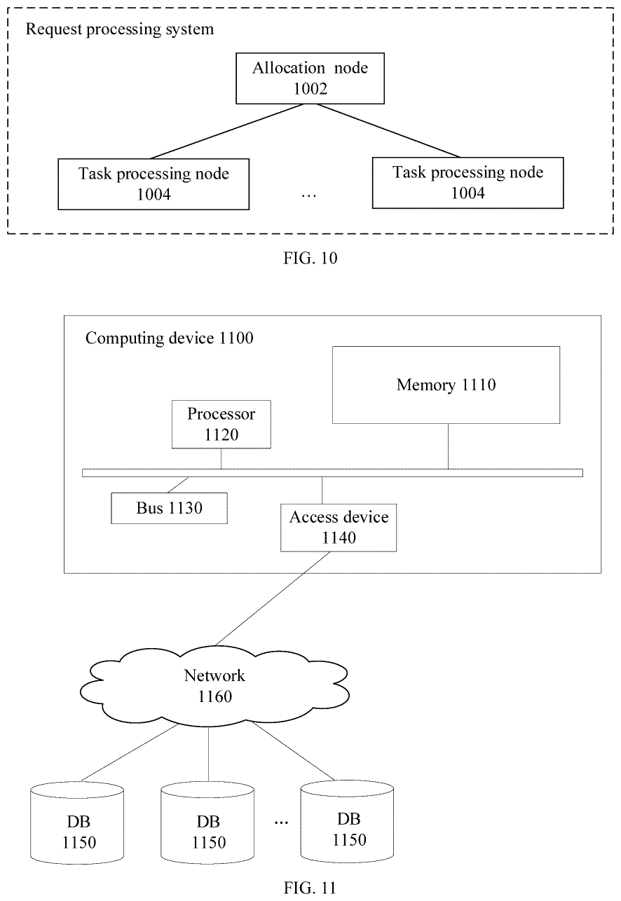

Referring to FIG. 9, it shows a flowchart of still another request processing method according to an embodiment of the present specification, where the request processing method is applied to an allocation node, the method specifically includes the following steps.

In step 902, at least two to-be-processed requests are received, and task response messages sent by at least two task processing nodes are received, where each of the task response messages carries a task processing weight.

In step 904, based on the task processing weight and the at least two to-be-processed requests, a corresponding to-be-processed request set is allocated to a first task processing node among the at least two task processing nodes, where the first task processing node is one of the at least two task processing nodes.

For explanation of the still another request processing method, refer to corresponding or relevant content in the above mentioned request processing method and the another request processing method, and details are not described herein again.

According to the still another request processing method applied to the allocation node provided in the present specification, the allocation node can receive the task processing weight determined by the task processing node according to the current processing state information during the performing task processing, and based on the task processing weight, determine the current processing state of each task processing node quickly and accurately, thereby avoiding the problem of delay. And then, when receiving the to-be-processed requests, the allocation node can allocate, based on the current processing state of each task processing node, the to-be-processed requests to the corresponding task processing node, thereby improving the request processing efficiency.

The above mentioned is a schematic solution of the still another request processing method according to this embodiment. It should be noted that the technical solution of the still another request processing method and the technical solution of the above mentioned request processing method belong to the same concept, and details that are not described in detail in the technical solution of the still another request processing method may refer to descriptions of the technical solution of the above mentioned request processing method.

Corresponding to the method embodiment described above, this specification further provides a request processing system embodiment, and FIG. 10 is a schematic structural diagram of a request processing system according to an embodiment of this specification. As shown in FIG. 10, the system comprises an allocation node 1002 and at least two task processing nodes 1004.

The allocation node 1002 is configured to: receive at least two to-be-processed requests, and receive task response messages sent by the at least two task processing nodes 1004, where each of the task response messages carries a task processing weight; and
allocate a corresponding to-be-processed request set to a first task processing node 1004 among the at least two task processing nodes 1004 based on the task processing weight and the at least two to-be-processed requests, where the first task processing node 1004 is one of the at least two task processing nodes 1004.

The first task processing node 1004 is configured to: perform task processing on one or more to-be-processed requests in a received to-be-processed request set, update the task processing weight according to current processing state information during the performing task processing, and send the updated task processing weight to the allocation node 1002 based on the task response messages.

Optionally, the allocation node 1002 is further configured to: determine, based on the task processing weight of the first task processing node 1004 among the at least two task processing nodes 1004, request set information corresponding to the first task processing node 1004; and
construct, based on the request set information and the at least two to-be-processed requests, the to-be-processed request set corresponding to the first task processing node 1004, and send the to-be-processed request set to the first task processing node 1004.

Optionally, the allocation node is further configured to: determine the first task processing node 1004 among the at least two task processing nodes 1004, and determine the task processing weight of the first task processing node 1004; and
determine, based on the number of requests of the at least two to-be-processed requests, the number of nodes of the at least two task processing nodes 1004, and the task processing weight, the request processing number of the first task processing node 1004, and take the request processing number as the request set information.

Optionally, the allocation node is further configured to: obtain one or more target to-be-processed requests corresponding to the request processing number of the first task processing node 1004 from the at least two to-be-processed requests; and
construct the to-be-processed request set corresponding to the first task processing node 1004 based on the one or more target to-be-processed requests, wherein the to-be-processed request set comprises the one or more target to-be-processed requests.

Optionally, the first task processing node 1004 is further configured to: monitor the current processing state information during the performing task processing; and
update, in response to determining that the current processing state information satisfies a predetermined condition for updating weight, the task processing weight based on the current processing state information and a predetermined parameter for updating weight.

Optionally, the current processing state information indicates the number of current concurrent requests, and the predetermined parameter for updating weight comprises a predetermined minimum threshold for concurrent requests and a predetermined maximum threshold for concurrent requests.

Accordingly, the first task processing node 1004 is further configured to: determine the predetermined minimum threshold for concurrent requests and the predetermined maximum threshold for concurrent requests; and
obtain updated task weight information based on the predetermined minimum threshold for concurrent requests, the predetermined maximum threshold for concurrent requests and the number of current concurrent requests, and replace the task processing weight based on the updated task weight information.

Optionally, the current processing state information indicates the number of current concurrent requests.

Accordingly, the first task processing node 1004 is further configured to determine, in response to determining that the number of current concurrent requests is greater than or equal to a predetermined minimum threshold for concurrent requests, the current processing state information satisfies the predetermined condition for updating weight.

Optionally, the current processing state information indicates the information of the current processing resource.

Accordingly, the first task processing node 1004 is further configured to determine, in response to determining that the information of the current processing resource is greater than or equal to a predetermined resource threshold, the current processing state information satisfies the predetermined condition for updating weight.

Optionally, the to-be-processed requests comprise the to-be-processed orders.

Accordingly, the allocation node 1002 is further configured to allocate, based on an order task processing weight and at least two to-be-processed orders, a corresponding to-be-processed order set to a first order processing node among at least two order processing nodes.

According to the request processing system provided in the present specification, the task processing node can determine the task processing weight according to the current processing state information during the performing task processing and actively send the determined task processing weight to the allocation node. While the allocation node can determine, based on the task processing weight, current processing state of each task processing node quickly and accurately, thereby avoiding the problem of delay. And then, when receiving the to-be-processed requests, the allocation node can allocate, based on the current processing state of each task processing node, the to-be-processed requests to the corresponding task processing node, thereby improving the request processing efficiency.

The above mentioned is a schematic solution of the request processing system according to this embodiment. It should be noted that the technical solution of the request processing system and the technical solution of the above mentioned request processing method belong to the same concept, and details that are not described in detail in the technical solution of the request processing system may refer to descriptions of the technical solution of the above mentioned request processing method.

Corresponding to the method embodiments described above, this specification further provides another request processing apparatus embodiment, and the request processing apparatus is applied to a task processing node, and includes:
a first sending module, configured to generate a task response message based on a task processing weight, and send the task response message to an allocation node;
a receiving module, configured to receive a to-be-processed request set determined by an allocation node for the task processing node, where the to-be-processed request set is determined by the allocation node based on the task processing weight and at least two received to-be-processed requests;
a processing module, configured to perform task processing on one or more to-be-processed requests in the received to-be-processed request set, and update the task processing weight according to current processing state information during the performing task processing; and
a second sending module, configured to send the updated task processing weight to the allocation node based on the task response message.

According to the another request processing apparatus applied to the task processing node provided in the present specification, the task processing node can determine the task processing weight according to the current processing state information during the performing task processing and actively send the determined task processing weight to the allocation node. While the allocation node can determine, based on the task processing weight, current processing state of each task processing node quickly and accurately, thereby avoiding the problem of delay. And then, when receiving the to-be-processed requests, the allocation node can allocate, based on the current processing state of each task processing node, the to-be-processed requests to the corresponding task processing node, thereby improving the request processing efficiency.

The above mentioned is a schematic solution of the another request processing apparatus according to this embodiment. It should be noted that the technical solution of the another request processing apparatus and the technical solution of the above mentioned request processing method belong to the same concept, and details that are not described in detail in the technical solution of the another request processing apparatus may refer to descriptions of the technical solution of the above mentioned request processing method.

Corresponding to the method embodiments described above, this specification further provides yet another request processing apparatus embodiment, and the request processing apparatus is applied to an allocation node, and includes:
a receiving module, configured to receive at least two to-be-processed requests, and receive task response messages sent by at least two task processing nodes, where each of the task response messages carries a task processing weight; and

an allocation module, configured to allocate, based on the task processing weight and the at least two to-be-processed requests, a corresponding to-be-processed request set to a first task processing node among the at least two task processing nodes, where the first task processing node is one of the at least two task processing nodes.

According to the yet another request processing apparatus applied to the allocation node provided in the present specification, the allocation node can receive the task processing weight determined by the task processing node according to the current processing state information during the performing task processing, and based on the task processing weight, determine the current processing state of each task processing node quickly and accurately, thereby avoiding the problem of delay. And then, when receiving the to-be-processed requests, the allocation node can allocate, based on the current processing state of each task processing node, the to-be-processed requests to the corresponding task processing node, thereby improving the request processing efficiency.

The above mentioned is a schematic solution of the yet another request processing apparatus according to this embodiment. It should be noted that the technical solution of the yet another request processing apparatus and the technical solution of the above mentioned request processing method belong to the same concept, and details that are not described in detail in the technical solution of the yet another request processing apparatus may refer to descriptions of the technical solution of the above mentioned request processing method.

FIG. 11 shows a structural block diagram of a computing device 1100 according to an embodiment of the present specification. Components of the computing device 1100 comprise, but are not limited to, a memory 1110 and a processor 1120. The processor 1120 is connected to the memory 1110 through a bus 1130, and a database 1150 is configured to store data.

The computing device 1100 further comprises an access device 1140 that enables the computing device 1100 to communicate via one or more networks 1160. Examples of these networks include the Public Switched Telephone Network (PSTN), Local Area Network (LAN), Wide Area Network (WAN), Personal Area Network (PAN), or a combination of communication networks such as the Internet. The access device 1140 may include one or more of any type of network interface (e.g., Network Interface Card (NIC)) wired or wireless, such as a IEEE802.11 Wireless Local Area Network (WLAN) wireless interface, a Worldwide Interoperability for Microwave Access (Wi-MAX) interface, an Ethernet interface, a Universal Serial Bus (USB) interface, a cellular network interface, a Bluetooth interface, a Near Field Communication (NFC) interface.

In an embodiment of the present specification, the above mentioned components of the computing device 1100 and other components not shown in FIG. 11 may also be connected to each other, for example, by a bus. It should be understood that the structural block diagram of the computing device shown in FIG. 11 is merely for example, and is not intended to limit the scope of the present specification. Those skilled in the art may add or replace other components as needed.

The computing device 1100 may be any type of stationary or mobile computing device, including a mobile computer or mobile computing device (e.g., tablet computer, personal digital assistant, laptop computer, notebook computer, netbook, etc.), a mobile phone (e.g., smartphone), a wearable computing device (e.g., smart watch, smart glasses, etc.), or other type of mobile device, or a stationary computing device such as a desktop computer or PC. The computing device 1100 may also be a mobile or stationary server.

The processor 1120 is configured to execute the following computer-executable instructions, when the computer-executable instructions are executed by the processor, the steps of the above mentioned request processing method are implemented.

The above mentioned is a schematic solution of the computing device according to this embodiment. It should be noted that the technical solution of the computing device and the technical solution of the above mentioned request processing method belong to the same concept, and details that are not described in detail in the technical solution of the computing device may refer to descriptions of the technical solution of the above mentioned request processing method.

An embodiment of the present specification further provides a computer-readable storage medium storing computer-executable instructions, when the computer-executable instructions are executed by a processor, steps of the above mentioned request processing methods are implemented.

The above mentioned is a schematic solution of the computer-readable storage medium according to this embodiment. It should be noted that the technical solution of the storage medium and the technical solution of the above mentioned request processing method belong to the same concept, and details that are not described in detail in the technical solution of the storage medium may refer to descriptions of the technical solution of the above mentioned request processing method.

An embodiment of the present specification further provides a computer program, where when the computer program is executed in a computer, the computer is enabled to perform the steps of the request processing methods above.

The above mentioned is a schematic solution of the computer program according to this embodiment. It should be noted that the technical solution of the computer program and the technical solution of the above mentioned request processing method belong to the same concept, and details that are not described in detail in the technical solution of the computer program may refer to descriptions of the technical solution of the above mentioned request processing method.

Specific embodiments of the present specification are described above. Other embodiments are within the scope of the appended claims. In some cases, the actions or steps recited in the claims may be performed in a different order than in the embodiments and still achieve desired results. Additionally, the processes depicted in the figures do not necessarily require a particular order or sequential order shown to achieve the desired results. In certain embodiments, multitasking and parallel processing are also possible or may be advantageous.

The computer instructions include computer program code, which may be in the form of source code, object code, executable files, some intermediate forms, or the like. The computer-readable medium may include any entity or device capable of carrying the computer program code, a recording medium, a USB flash disk, a mobile hard disk, a magnetic disk, an optical disk, a computer memory, a Read-Only Memory (ROM), a Random Access Memory (RAM), an electrical carrier signal, a telecommunication signal, a software distribution medium, and the like. It should be noted that the content stored in the computer-readable storage medium can be appropriately increased or decreased in accordance with legislative requirements and regulations of patent practice in a jurisdiction, for example, in some jurisdictions, legislation and patent practice stipulating that a computer-readable medium does not include electrical carrier signals or telecommunications signals.

It should be noted that, for the method embodiments described above, for ease of description, all the method embodiments are expressed as a series of action combinations, but those skilled in the art should know that the embodiments of the present specification are not limited by the described action sequence, because according to the embodiments of the present specification, some steps may be performed in other sequences or simultaneously. Secondly, those skilled in the art should also know that the embodiments described in the specification all belong to preferred embodiments, and the actions and modules involved are not necessarily required in the embodiments of the specification.

In the above embodiments, the description of each embodiment has its emphasis, and parts not described in detail in a certain embodiment may refer to the relevant descriptions of other embodiments.

The preferred embodiments of the present specification disclosed above are only used to help illustrate the present specification. The alternative embodiments neither present all details, nor imply that the present disclosure is limited to the specific embodiments. Obviously, many modifications and changes may be made according to the content of the embodiments of the present specification. These embodiments are presented and some details are described herein only for explaining the principles and practical applications of the embodiments of this specification, so that a person skilled in the art can well understand and use this specification. This specification is limited only by the claims and their full scope and equivalents.

1. A request processing method, applied to a request processing system comprising an allocation node and at least two task processing nodes, comprising:
by the allocation node,
receiving at least two to-be-processed requests, and receiving task response messages sent by the at least two task processing nodes, wherein each of the task response messages carries a task processing weight of a corresponding task processing node, and
allocating, based on the task processing weight and the at least two to-be-processed requests, a corresponding to-be-processed request set to a first task processing node, wherein the first task processing node is one of the at least two task processing nodes; and
by the first task processing node,
performing task processing on one or more to-be-processed requests in a received to-be-processed request set,
updating the task processing weight according to current processing state information during the performing task processing, and
sending the updated task processing weight to the allocation node based on the task response messages.

2. The request processing method according to claim 1, wherein the allocating, based on the task processing weight and the at least two to-be-processed requests, a corresponding to-be-processed request set to a first task processing node comprises:
by the allocation node,
determining, request set information corresponding to the first task processing node based on the task processing weight of the first task processing node,
constructing, the to-be-processed request set corresponding to the first task processing node based on the request set information and the at least two to-be-processed requests, and
sending, the to-be-processed request set to the first task processing node.

3. The request processing method according to claim 2, wherein the determining, request set information corresponding to the first task processing node based on the task processing weight of the first task processing node comprises:
by the allocation node,
determining the first task processing node from the at least two task processing nodes, and determining the task processing weight of the first task processing node,
determining, based on a number of requests of the at least two to-be-processed requests, a number of nodes of the at least two task processing nodes and the task processing weight, a request processing number of the first task processing node as the request set information.

4. The request processing method according to claim 3, wherein the constructing the to-be-processed request set corresponding to the first task processing node based on the request set information and the at least two to-be-processed requests comprises:
by the allocation node,
obtaining one or more target to-be-processed requests corresponding to the request processing number of the first task processing node from the at least two to-be-processed requests, and
constructing, the to-be-processed request set corresponding to the first task processing node based on the one or more target to-be-processed requests, wherein the to-be-processed request set comprises the one or more target to-be-processed requests.

5. The request processing method according to claim 1, wherein the updating the task processing weight according to current processing state information during the performing task processing comprises:
by the first task processing node,
monitoring the current processing state information during the performing task processing, and
updating, in response to determining that the current processing state information satisfies a predetermined condition for updating weight, the task processing weight based on the current processing state information and a predetermined parameter for updating weight.

6. The request processing method according to claim 5, wherein the current processing state information indicates a number of current concurrent requests, and the predetermined parameter for updating weight comprises a predetermined minimum threshold for concurrent requests and a predetermined maximum threshold for concurrent requests;
wherein the updating the task processing weight based on the current processing state information and a predetermined parameter for updating weight comprises:
by the first task processing node,
determining updated task weight information based on the predetermined minimum threshold for concurrent requests, the predetermined maximum threshold for concurrent requests and the number of current concurrent requests, and
updating the task processing weight based on the updated task weight information.

7. The request processing method according to claim 5, wherein the current processing state information indicates a number of current concurrent requests;
wherein the predetermined condition for updating weight comprises:
the number of current concurrent requests is greater than or equal to a predetermined minimum threshold for concurrent requests.

8. The request processing method according to claim 5, wherein the current processing state information indicates information related to a current processing resource;
wherein the predetermined condition for updating weight comprises:
the information related to the current processing resource indicates the current processing resource being greater than or equal to a predetermined resource threshold.

9. The request processing method according to claim 1, wherein the to-be-processed requests comprise to-be-processed orders;
wherein the allocating, based on the task processing weight and the at least two to-be-processed requests, a corresponding to-be-processed request set to a first task processing node comprises:
allocating, by the allocation node and based on an order task processing weight and at least two to-be-processed orders, a corresponding to-be-processed order set to a first order processing node among at least two order processing nodes.

10. A request processing method, applied to a task processing node, comprising:
generating a task response message based on a task processing weight;
sending the task response message to an allocation node;
receiving a to-be-processed request set determined by the allocation node for the task processing node, wherein the to-be-processed request set is determined based on the task processing weight and at least two to-be-processed requests received by the allocation node;
performing task processing on one or more to-be-processed requests in the received to-be-processed request set;
updating the task processing weight according to current processing state information during the performing task processing; and
sending the updated task processing weight to the allocation node based on the task response message.

11. A request processing method, applied to an allocation node, comprising:
receiving at least two to-be-processed requests, and receiving task response messages sent by at least two task processing nodes, wherein each of the task response messages carries a task processing weight of a corresponding task processing node; and
allocating, based on the task processing weight and the at least two to-be-processed requests, a corresponding to-be-processed request set to a first task processing node, wherein the first task processing node is one of the at least two task processing nodes.

12. (canceled)

13. A computing device, comprising:
a memory and a processor;
wherein the memory is configured to store computer-executable instructions, the processor is configured to execute the computer-executable instructions, and when the computer-executable instructions are executed by the processor, the request processing method according to claim 10 is implemented.

14. A non-transitory computer-readable storage medium storing computer-executable instructions which, when executed by a processor, implement steps of the request processing method according to claim 10.

15. The request processing method according to claim 10, wherein the updating the task processing weight according to current processing state information during the performing task processing comprises:
monitoring the current processing state information during the performing task processing, and
updating, in response to determining that the current processing state information satisfies a predetermined condition for updating weight, the task processing weight based on the current processing state information and a predetermined parameter for updating weight.

16. The request processing method according to claim 15, wherein the current processing state information indicates a number of current concurrent requests, and the predetermined parameter for updating weight comprises a predetermined minimum threshold for concurrent requests and a predetermined maximum threshold for concurrent requests;
wherein the updating the task processing weight based on the current processing state information and a predetermined parameter for updating weight comprises:
determining updated task weight information based on the predetermined minimum threshold for concurrent requests, the predetermined maximum threshold for concurrent requests and the number of current concurrent requests, and
updating the task processing weight based on the updated task weight information.

17. The request processing method according to claim 15, wherein the current processing state information indicates a number of current concurrent requests; the predetermined condition for updating weight comprises: the number of current concurrent requests is greater than or equal to a predetermined minimum threshold for concurrent requests; or
wherein the current processing state information indicates information related to a current processing resource, the predetermined condition for updating weight comprises: the information related to the current processing resource indicates the current processing resource being greater than or equal to a predetermined resource threshold.

18. The request processing method according to claim 11, wherein the allocating, based on the task processing weight and the at least two to-be-processed requests, a corresponding to-be-processed request set to a first task processing node comprises:
determining, request set information corresponding to the first task processing node based on the task processing weight of the first task processing node,
constructing, the to-be-processed request set corresponding to the first task processing node based on the request set information and the at least two to-be-processed requests, and
sending, the to-be-processed request set to the first task processing node.

19. The request processing method according to claim 18, wherein the determining, request set information corresponding to the first task processing node based on the task processing weight of the first task processing node comprises:
determining the first task processing node from the at least two task processing nodes, and determining the task processing weight of the first task processing node,
determining, based on a number of requests of the at least two to-be-processed requests, a number of nodes of the at least two task processing nodes and the task processing weight, a request processing number of the first task processing node as the request set information.

20. The request processing method according to claim 19, wherein the constructing the to-be-processed request set corresponding to the first task processing node based on the request set information and the at least two to-be-processed requests comprises:
obtaining one or more target to-be-processed requests corresponding to the request processing number of the first task processing node from the at least two to-be-processed requests, and
constructing, the to-be-processed request set corresponding to the first task processing node based on the one or more target to-be-processed requests, wherein the to-be-processed request set comprises the one or more target to-be-processed requests.

21. A computing device, comprising:
a memory and a processor;
wherein the memory is configured to store computer-executable instructions, the processor is configured to execute the computer-executable instructions, and when the computer-executable instructions are executed by the processor, the request processing method according to claim 11 is implemented.
